(19) United States
(12) Patent Application Publication
(10) Pub. No.: US 2009/0295716 A1
(43) Pub. Date: Dec. 3, 2009

(54) METHOD FOR MOVING CURSOR AND STORAGE MEDIUM THEREOF

(75) Inventor: Cheng-Sung Lee, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: COMPAL ELECTRONICS, INC., Taipei City (TW)

(21) Appl. No.: 12/177,890

(22) Filed: Jul. 23, 2008

(30) Foreign Application Priority Data
Jun. 3, 2008 (TW) 97120640

(51) Int. Cl. G06F 3/033

(52) U.S. Cl. 345/157

(57) ABSTRACT

A method for moving cursor and a storage medium thereof are provided for a computer system connected to a first display and a second display. In the present method, a user-define cursor position in the second display is stored when a cursor position storing instruction is received. After a cursor moving instruction is received, the cursor located in the first display is switched and displayed at the user-define cursor position in the second display. And the cursor in the second display is switched and displayed on the previous position of the first display if the cursor moving instruction is received again. As a result, the operation of dragging a mouse repeatedly to move the cursor can be avoided, so that the cursor can be directly and quickly moved to a position predetermined by a user. Accordingly, utilization facility of an extended display is improved.

### CROSS-REFERENCE TO RELATED APPLICATION

This application claims the priority benefit of Taiwan application serial no. 97120640, filed on Jun. 3, 2008. The entirety of the above-mentioned patent application is hereby incorporated by reference herein and made a part of specification.

### BACKGROUND OF THE INVENTION

1. Field of the Invention

The present invention relates to an application of an extended display. More particularly, the present invention relates to a method for moving a cursor and a storage medium thereof when an extended display is applied.

2. Description of Related Art

An extended display is referred to as a technique that a single display card of a computer system is connected to two or more displays, so that a desktop of a windows operating system may bestride a plurality of the displays, and an utilization space of a single screen desktop is expended. Such technique is essential for laptop computer users. Generally, since a screen size of a laptop computer is relatively small, if a plurality of application program windows is opened, the windows have to be displayed on the desktop in overlap, which may lead to inconvenience for checking contents of the windows. To solve the above problem, an extended display technique can be applied, by which more than one displays are connected, so as to display a part of the windows in the extended displays.

However, with development of display techniques, resolutions of the displays are increased. A plurality of 19-inch displays in the market may support a 1600*1200 resolution. Previously, when a display with 800*600 resolution is applied, a cursor thereof can be moved to a specific position by dragging a mouse once. Though, if a display with a relatively high resolution is applied, the mouse has to be dragged repeatedly for moving the cursor to the specific position. The more times the mouse is dragged, the slower the cursor moves. In other words, when a relatively great desktop is utilized, a relatively long time is spent for locating the cursor to the specific position. Therefore, for the extended display users, the mouse has to be repeatedly dragged to switch the cursor among different displays, so as to perform different operations. Accordingly, a lot of time is wasted for such operation, and a working efficiency thereof is decreased.

### SUMMARY OF THE INVENTION

Accordingly, the present invention is directed to a method for moving a cursor, by which under an environment of an extended display, the cursor can be directly moved to a predetermined position or a working window being operated via operation of an external input device, so as to avoid an inconvenience of moving the cursor among displays caused by repeatedly dragging a mouse.

The present invention provides a method for moving a cursor, suitable for a computer system connected to a first display and a second display. In the present method, a user-define cursor position is stored when a cursor position storing instruction is received, wherein the user-define cursor position is located in the second display. Next, after a cursor moving instruction is received, the cursor located in the first display is switched and displayed to the user-define cursor position in the second display, or the cursor located in the second display is switched and displayed to a previous position in the first display.

In an embodiment of the present invention, before the cursor moving instruction is received, a system predetermined cursor position is further provided, wherein the system predetermined cursor position is in the second display.

In an embodiment of the present invention, after the cursor moving instruction is received, a working window being operated when the cursor is previously located in the second display is obtained, wherein the working window is displayed in the second display. Next, the cursor is switched and displayed in the working window.

In an embodiment of the present invention, each time when the cursor is moved to the first display from the second display, the working window being operated is recorded.

In an embodiment of the present invention, before the cursor moving instruction is received, a menu having a first mode option, a second mode option and a third mode option is further displayed. When an option selecting instruction is received, if the option selecting instruction corresponds to the first mode option, a cursor moving mode of the computer system is then recorded as a first mode; if the option selecting instruction corresponds to the second mode option, the cursor moving mode is then recorded as a second mode; and if the option selecting instruction corresponds to the third mode option, the cursor moving mode is then recorded as a third mode.

In an embodiment of the present invention, after the cursor moving instruction is received, a cursor moving mode is further obtained. When the cursor moving mode is the first mode, the cursor located at the first display is switched and displayed to the user-define cursor position. When the cursor moving mode is the second mode, the cursor located at the first display is switched and displayed to the system predetermined cursor position. When the cursor moving mode is the third mode, the cursor located at the first display is switched and displayed to the working window.

In an embodiment of the present invention, the step of switching and displaying the cursor includes flickeringly displaying the cursor at the user-define cursor position, the system predetermined cursor position and the working window.

In an embodiment of the present invention, the cursor moving instruction is triggered by an external input device, and the external input device is for example, a mouse or a keyboard.

The present invention provides a method for moving a cursor, suitable for a computer system connected to a first display and a second display, for moving the cursor displayed in the first display to the second display. The method can be described as follows. First, a cursor moving instruction is received. Next, a working window being operated when the cursor is previously located in the second display is obtained, wherein the working window is displayed in the second display. Finally, the cursor is switched and displayed in the working window.

In an embodiment of the present invention, each time when the cursor is moved to the first display from the second display, a working window being operated is recorded.

In an embodiment of the present invention, the step of switching and displaying the cursor includes flickeringly displaying the cursor in the working window.

In an embodiment of the present invention, the cursor moving instruction is triggered by an external input device, and the external input device is for example, a mouse or a keyboard.

The present invention provides a storage medium for storing a computer program. The computer program includes a plurality of program codes used for being loaded to a computer system connected to a first display and a second display, so that the computer system may execute the aforementioned method for moving a cursor.

In the present invention, not only the moving destination of the cursor can be predetermined by the user, but also the working window being previously operated can be automatically detected. Accordingly, when the cursor is about to be moved to another display, the cursor can be directly and quickly moved to the predetermined position or the working window, so as to avoid an inconvenience caused by repeatedly dragging the mouse, and improve a utilization facility of an extended display.

In order to make the aforementioned and other objects, features and advantages of the present invention comprehensible, a preferred embodiment accompanied with figures is described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart illustrating a method for moving a cursor according to an embodiment of the present invention.

FIG. 2 is a flowchart illustrating a method for moving a cursor according to another embodiment of the present invention.

FIG. 3 is a flowchart illustrating a method for moving a cursor according to still another embodiment of the present invention.

FIG. 4 is a flowchart illustrating a method for moving a cursor according to yet another embodiment of the present invention.

### DESCRIPTION OF EMBODIMENTS

For a programmer, a draftsman or a web designer, a plenty of application program windows are required to be simultaneously opened during working. Therefore, an extended display technique is generally applied to extend a utilization space of a desktop, so as to facilitate the work. Under the extended display environment, moving of a cursor among displays can be speed-up, so that a smooth operation thereof can be achieved. According to the above aspects, the present invention provides a method for moving a cursor and a storage medium thereof. To fully convey the concept of the present invention, embodiments are provided below for describing the present invention in detail.

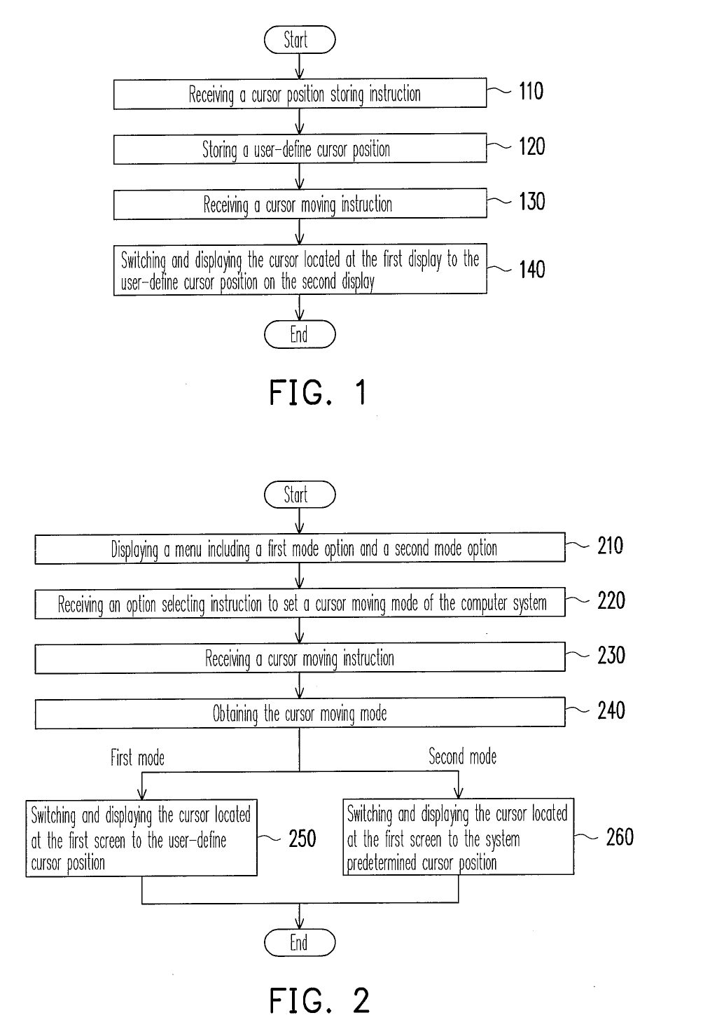

FIG. 1 is a flowchart illustrating a method for moving a cursor according to an embodiment of the present invention. Referring to FIG. 1, in the present embodiment, a computer system connected to a first display and a second display is taken as an example for describing steps of moving the cursor from the first display to the second display. Wherein, the first display is for example, a main display of the computer system, and the second display can be the extended display, though the present invention is not limited thereto.

In the present embodiment, a user may set the cursor position in the second display when the cursor is moved thereto according to an operation habit of the user. Accordingly, when the user operates the computer system with the second display, an application program specially recording and managing the cursor position can be called at any time via operation of an external input device such as pressing a right button of a mouse or pressing a special key of a keyboard, so as to trigger a cursor position storing instruction.

In step 110, the computer system receives the cursor position storing instruction triggered by the user. Next, in step 120, the computer system automatically takes a current cursor position as a user-define cursor position, and stores the user-define cursor position located at the second display.

After the aforementioned operations, the user may still operate the computer system. Thereafter, assuming the cursor currently located at the first display is about to be moved to the second display, a cursor moving instruction is then triggered via the operation of the external input device. Wherein, the external input device can be a mouse or a keyboard, which is not limited by the present invention. The method of triggering the cursor moving instruction includes pressing a predetermined key on the keyboard or continuously pressing a mouse key, etc, which is also not limited by the present invention.

In step 130, the cursor moving instruction triggered by the user is received. Finally, in step 140, the cursor located on the first display is automatically switched and displayed at the user-define cursor position on the second display. To clearly notify the user a cursor moving state, in the present embodiment, the cursor is flickered and displayed at the user-define cursor position, so as to further notify the user that the cursor position is changed.

According to the present embodiment, the user may not only define a displaying position of the cursor when the cursor is moved to another display, but may also quickly and directly move the cursor to the user-define cursor position via simply operation the external input device, so that a situation that the mouse has to be dragged repeatedly for moving the cursor to the other display during utilization of the extended display can be avoided.

Continue with the above embodiment, besides the user-define cursor position can be defined via the steps 110 and 120 of FIG. 1, a system predetermined cursor position located at the second display is further stored in the computer system. Wherein, the system predetermined cursor position is for example located at center of the second display, or located at a top-right corner of a displayed window of the second display (for example, located at status buttons for shrinking, restoring or closing the window), which is not limited by the present invention. In the present embodiment, the user-define cursor position is the cursor position that can be defined by the user at any time, and as long as the cursor position storing instruction is triggered, a current position of the cursor is then recorded in the computer system to serve as the user-define cursor position. While, the system predetermined cursor position is the cursor position fixedly stored in the computer system. Correspondingly, the user-define cursor position is quite flexible, which can be set to any position on the display according to an actual requirement, though the system predetermined cursor position remains unchangeable.

FIG. 2 is a flowchart illustrating a method for moving a cursor according to another embodiment of the present invention. Referring to FIG. 2, first, in step 210, a menu including a first mode option and a second mode option is displayed.

Next, in step 220, an option selecting instruction is received for setting a cursor moving mode of the computer system. Namely, when the user operates the computer system, he may call the aforementioned menu at any time to set the cursor moving mode. If the option selecting instruction triggered by the user corresponds to the first mode option, the cursor moving mode of the computer system is then set to a first mode; conversely, if the option selecting instruction corresponds to the second mode option, the cursor moving mode of the computer system is then set to a second mode.

Next, in step 230, a cursor moving instruction triggered by the user is received. In the present embodiment, the cursor moving instruction is triggered via the operation of the external input device, wherein the external input device can by a mouse or a keyboard, etc, which is not limited by the present invention.

After the cursor moving instruction is received, in step 240, the computer system automatically obtains the current cursor moving mode. If the cursor moving mode is the first mode, in step 250, the cursor located at the first display is automatically switched and displayed to the previous user-define cursor position. If the cursor moving mode is the second mode, in step 260, the cursor located at the first display is switched and displayed to the system predetermined cursor position. Wherein, the method of displaying the cursor on the second display includes flickeringly displaying the cursor, so as to definitely notify the user the current cursor position.

Regardless of which cursor moving mode is selected from the menu, after the cursor moving instruction is triggered by operating the external input device, the cursor can be quickly moved from the first display to the user-define cursor position on the second display, or to the system predetermined cursor position. Therefore, the cursor can be directly moved to an extended desktop of the second display without dragging the mouse repeatedly, so that operation efficiency of the mouse can be greatly improved.

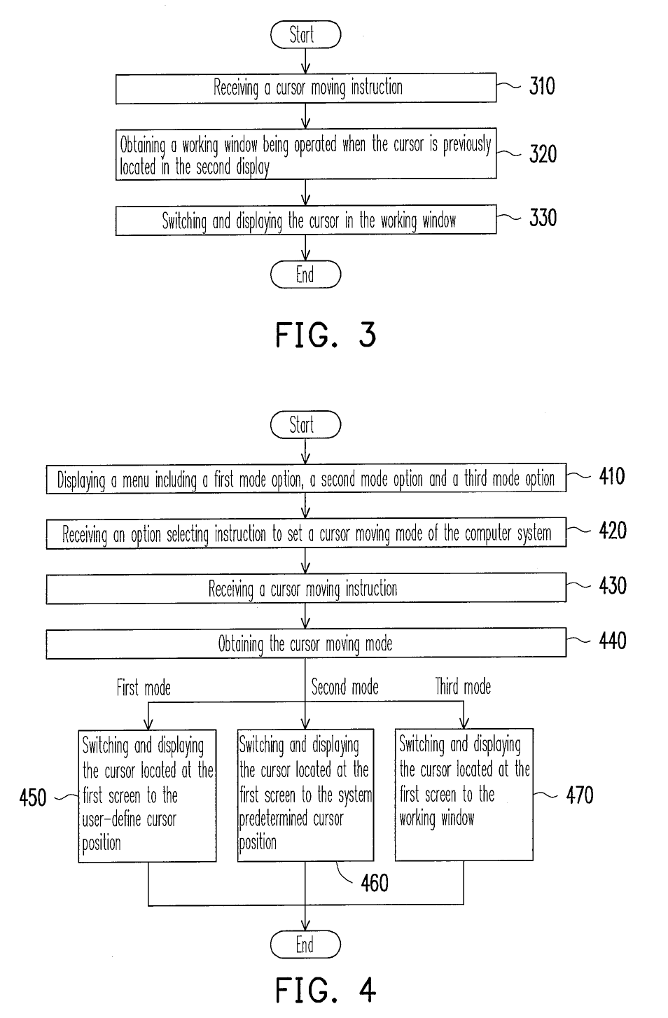

In a next embodiment, the second display simultaneously displays a plurality of application program windows, and each time when the cursor is moved to the first display from the second display, the window being currently operated is then recorded as a working window, and is stored in the computer system. FIG. 3 is a flowchart illustrating a method for moving a cursor from a first display to a second display. Referring to FIG. 3, first, in step 310, the cursor moving instruction is received. Next, in step 320, the working window being operated in the second display when the cursor is previously located at the second display is automatically obtained. Finally, in step 330, the cursor is directly switched and displayed in the working window, so as to complete switching of the cursor position. Wherein, the method of displaying the cursor in the working window includes for example, flickeringly displaying the cursor in the working window, so as to notify the user that the cursor position is changed.

In the aforementioned embodiment, when the cursor is moved to the first display from the second display, the working window being operated by the user is recorded in the computer system. Thereafter, when the cursor is again moved to the second display from the first display, a cursor moving instruction is then triggered via the external input device (such as the keyboard or the mouse), so as to directly move the cursor to the working window previously operated by the user.

FIG. 4 is a flowchart illustrating a method for moving a cursor according to still another embodiment of the present invention. In the present embodiment, the computer system is recorded with the user-define cursor position, the system predetermined cursor position and the working window in the second display being previously operated by the user. First, in step 410, a method simultaneously displaying a first mode option, a second mode option and a third mode option is provided, wherein the three options respectively correspond to three cursor moving modes. Next, in step 420, an option selecting instruction is triggered by selecting an option on the menu. The computer system then determines the cursor moving mode according to the received option selecting instruction. Next, in step 430, the computer system receives a cursor moving instruction, and in step 440, the cursor moving mode is received. Next, the cursor is directly moved to the user-define cursor position (step 450), the system predetermined cursor position (step 460) or the working window (step 470) according to the cursor moving mode. However, the method of setting the user-define cursor position, the method of detecting the working window, and the method of moving the cursor according to the cursor moving instruction are the same or similar to that described in the aforementioned embodiment, and therefore detailed description thereof will not be repeated.

It should be noted that the aforementioned methods for moving the cursor can be applied to any computer system simultaneously connected to a first display and a second display. In other words, the aforementioned methods can be designed to be a computer program including a plurality of program codes, and the program codes can be stored in a storage medium (such as a compact disc, a floppy disk or a removable disk, etc.) that can be read by the computer system. After the computer program is loaded to the computer system, the method for moving the cursor then can be executed on the computer system, so as to quickly move the cursor from the first display to the second display.

It should be further noted that though in the aforementioned embodiments the cursor is switched and displayed to the second display from the first display, the cursor located at the second display can also be directly switched and displayed to the first display based on the flowchart illustrated in FIGS. 1-4, so that the cursor can be quickly switched and displayed on any of the displays connected to the computer system.

In summary, according to the method for moving the cursor and a storage medium thereof of the present invention, a quick and flexible method is provided for moving the cursor from the first display to the second display. In which the position where the cursor is to be moved to, or the system predetermined position, or even the working window being previously operated can be defined by the user. Therefore, the cursor can be directly moved among the displays without dragging the mouse repeatedly, so that operation efficiency of the computer system can be greatly improved, and utilization facility of the extended display can be improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for moving a cursor, suitable for a computer system connected to a first display and a second display, the method comprising:
receiving a cursor position storing instruction;
storing a user-define cursor position, wherein the user-define cursor position is located at the second display;
receiving a cursor moving instruction; and
switching and displaying the cursor located at the first display to the user-define cursor position on the second display.

2. The method for moving a cursor as claimed in claim 1, wherein before the step of receiving the cursor moving instruction, the method further comprises:
providing a system predetermined cursor position, wherein the system predetermined cursor position is located at the second display.

3. The method for moving a cursor as claimed in claim 2, wherein after the step of receiving the cursor moving instruction, the method further comprises:
obtaining a working window being operated when the cursor is previously located in the second display, wherein the working window is displayed in the second display; and
switching and displaying the cursor in the working window.

4. The method for moving a cursor as claimed in claim 3, further comprising:
recording the working window being currently operated, each time when the cursor is moved to the first display from the second display.

5. The method for moving a cursor as claimed in claim 3, wherein before the step of receiving the cursor moving instruction, the method further comprises:
displaying a menu including a first mode option, a second mode option and a third mode option;
receiving an option selecting instruction;
recording a cursor moving mode of the computer system as a first mode when the option selecting instruction corresponds to the first mode option;
recording the cursor moving mode as a second mode when the option selecting instruction corresponds to the second mode option; and
recording the cursor moving mode as a third mode when the option selecting instruction corresponds to the third mode option.

6. The method for moving a cursor as claimed in claim 5, wherein after the step of receiving the cursor moving instruction, the method further comprises:
obtaining the cursor moving mode;
switching and displaying the cursor located at the first display to the user-define cursor position when the cursor moving mode is the first mode;
switching and displaying the cursor located at the first display to the system predetermined cursor position when the cursor moving mode is the second mode; and
switching and displaying the cursor located at the first display to the working window when the cursor moving mode is the third mode.

7. The method for moving a cursor as claimed in claim 3, wherein the step of switching and displaying the cursor comprises:
flickeringly displaying the cursor at the user-define cursor position, the system predetermined cursor position or the working window.

8. The method for moving a cursor as claimed in claim 1, wherein the cursor moving instruction is triggered via an external input device.

9. The method for moving a cursor as claimed in claim 8, wherein the external input device comprises one of a mouse and a keyboard.

10. A method for moving a cursor, suitable for a computer system connected to a first display and a second display, for moving the cursor located at the first display to the second display, the method comprising:
receiving a cursor moving instruction;
obtaining a working window being operated when the cursor is previously located in the second display, wherein the working window is displayed in the second display; and
switching and displaying the cursor in the working window.

11. The method for moving a cursor as claimed in claim 10, further comprising:
recording the working window being currently operated, each time when the cursor is moved to the first display from the second display.

12. The method for moving a cursor as claimed in claim 10, wherein the step of switching and displaying the cursor to the working window comprises:
flickeringly displaying the cursor in the working window.

13. The method for moving a cursor as claimed in claim 10, wherein the cursor moving instruction is triggered via an external input device.

14. The method for moving a cursor as claimed in claim 13, wherein the external input device comprises one of a mouse and a keyboard.

15. A storage medium, for storing a computer program comprising a plurality of program codes, wherein the computer program is loaded to a computer system connected to a first display and a second display, so that the computer system executes a method for moving a cursor, and the method comprises:
receiving a cursor position storing instruction;
storing a user-define cursor position, wherein the user-define cursor position is located at the second display;
receiving a cursor moving instruction; and
switching and displaying the cursor located at the first display to the user-define cursor position on the second display.

16. The storage medium as claimed in claim 15, wherein before the step of receiving the cursor moving instruction, the method further comprises:
providing a system predetermined cursor position, wherein the system predetermined cursor position is located at the second display.

17. The storage medium as claimed in claim 16, wherein after the step of receiving the cursor moving instruction, the method further comprises:
obtaining a working window being operated when the cursor is previously located in the second display, wherein the working window is displayed in the second display; and
switching and displaying the cursor in the working window.

18. The storage medium as claimed in claim 17, further comprising:
recording the working window being currently operated, each time when the cursor is moved to the first display from the second display.

19. The storage medium as claimed in claim 17, wherein before the step of receiving the cursor moving instruction, the method further comprises:
displaying a menu including a first mode option, a second mode option and a third mode option;
receiving an option selecting instruction;
recording a cursor moving mode of the computer system as a first mode when the option selecting instruction corresponds to the first mode option;
recording the cursor moving mode as a second mode when the option selecting instruction corresponds to the second mode option; and
recording the cursor moving mode as a third mode when the option selecting instruction corresponds to the third mode option.

20. The storage medium as claimed in claim 19, wherein after the step of receiving the cursor moving instruction, the method further comprises:
obtaining the cursor moving mode;
switching and displaying the cursor located at the first display to the user-define cursor position when the cursor moving mode is the first mode;
switching and displaying the cursor located at the first display to the system predetermined cursor position when the cursor moving mode is the second mode; and
switching and displaying the cursor located at the first display to the working window when the cursor moving mode is the third mode.

21. The storage medium as claimed in claim 17, wherein the step of switching and displaying the cursor comprises:
flickeringly displaying the cursor at the user-define cursor position, the system predetermined cursor position or the working window.

22. The storage medium as claimed in claim 15, wherein the cursor moving instruction is triggered via an external input device.

23. The storage medium as claimed in claim 22, wherein the external input device comprises one of a mouse and a keyboard.

24. A storage medium, for storing a computer program comprising a plurality of program codes, wherein the computer program is loaded to a computer system connected to a first display and a second display, so that the computer system executes a method for moving a cursor, and the method comprises:
receiving a cursor moving instruction;
obtaining a working window being operated when the cursor is previously located in the second display, wherein the working window is displayed in the second display; and
switching and displaying the cursor in the working window.

25. The storage medium as claimed in claim 24, further comprising:
recording the working window being currently operated, each time when the cursor is moved to the first display from the second display.

26. The storage medium as claimed in claim 24, wherein the step of switching and displaying the cursor to the working window comprises:
flickeringly displaying the cursor in the working window.

27. The storage medium as claimed in claim 24, wherein the cursor moving instruction is triggered via an external input device.

28. The storage medium as claimed in claim 27, wherein the external input device comprises one of a mouse and a keyboard.
